(19) United States
(12) Patent Application Publication
(10) Pub. No.: US 2010/0070349 A1
(43) Pub. Date: Mar. 18, 2010

(54) ROAD TOLL SYSTEM

(75) Inventor: Frank C. H. Daems, Rotselaar (BE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/517,260

(22) PCT Filed: Nov. 29, 2007
(86) PCT No.: PCT/IB2007/054840

§ 371 Date: Jun. 4, 2009

(30) Foreign Application Priority Data
Dec. 4, 2006 (GB) 0624191.3

(51) Int. Cl. G07B 15/00; G01S 19/25; G06F 7/00

(52) U.S. Cl. 705/13; 342/357.07; 701/36; 342/357.04

(57) ABSTRACT

A road toll system comprises a vehicle-mounted unit comprising a satellite navigation receiver implementing a position tracking function, a memory device storing toll payment information and means for determining the routes taken by the vehicle based on the position tracking information. A disabling system is provided for disabling the vehicle operation based on the toll payment information. This system uses a satellite navigation receiver to enable infrastructure-free road tolling to be implemented. The system includes a function disabling the vehicle if the road toll fees have not been paid. This saves effort in tracking down users that do not pay their tolls.

This invention relates to road toll systems, for implementing an automatic payment system for deducting road tolls based on the road sections used.

The integrated use of telecommunications and informatics is known as telematics. Vehicle telematics systems may be used for a number of purposes, including collecting road tolls, managing road usage (intelligent transportation systems), tracking fleet vehicle locations, recovering stolen vehicles, providing automatic collision notification, location-driven driver information services and in-vehicle early warning notification alert systems (car accident prevention).

Road tolling is considered as the first likely large volume market for vehicle telematics. Telematics is now beginning to enter the consumer car environment as a multimedia service box for closed services. These markets are still low in volume and are considered as niche markets. The European union and with The Netherlands as a leading country has the intention to introduce road tolling as an obligatory function for every car from 2012 onwards.

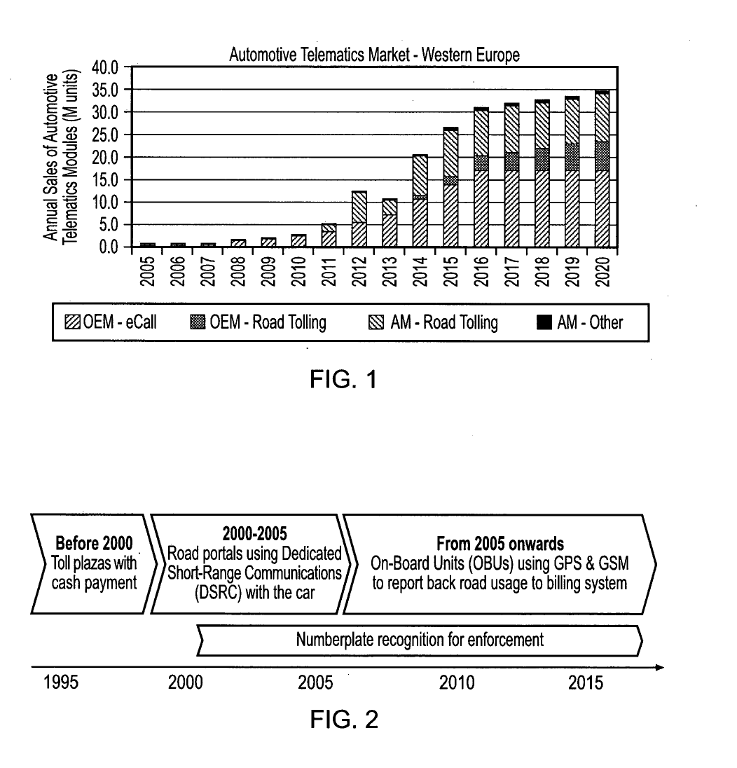

FIG. 1 shows the expected volumes for different telematic services over time in Western Europe. The telematics service market is split up into three main parts: road tolling service, e-call (emergency service) and other generic services (such as outlined above). The figure also shows the split between original equipment manufacturers (OEM) namely vehicle manufacturers, and after market (AM) products.

FIG. 1 assumes that road tolling will start in the Netherlands in 2012, and will be taken up in other countries around 2014 to 2020. It also assumes that the e-call system will not be made mandatory.

Generally, FIG. 1 shows a rapid growth in telematic in-car systems over time.

FIG. 2 shows how road tolling functions have been implemented in the past and how this is expected to change in future.

So far, road tolling has been used for high way billing, truck billing and billing for driving a car in a certain area (e.g. London city). Toll plazas at which vehicles must stop are generally used, or else short range communications systems allow automatic debiting of a fund when a vehicle passes.

The road tolling functions needed in the near future will impose the requirement for less (or no) infrastructure and will impose tolling for every mile driven.

As shown in FIG. 2, it is envisaged that the vehicle will have a GPS system on board and a GSM (mobile telephony network) connection to enable information to be relayed to a centralized road tolling system.

The charging system in an automated road toll system can be based on distance traveled, the time, location and vehicle characteristics. The road tolling may apply to all vehicles or it may exclude certain classes of vehicle (for example with foreign number plates).

U.S. Pat. No. 6,816,707 describes a system consisting of a mobile device and a vehicle unit for mounting in the vehicle. The mobile device is the transaction device. The vehicle unit carries the identity (and maybe other data) of the vehicle. The mobile device and the vehicle unit mutually authenticate each other.

There is a need to increase the security of this type of system and to make fraudulent use of the system as difficult as possible. There is also a need to prevent unauthorised use of roads as quickly as possible.

According to the invention, there is provided a road toll system comprising a vehicle-mounted unit comprising:

a satellite navigation receiver implementing a position tracking function;

a memory device storing toll payment information;

means for determining the routes taken by the vehicle based on the position tracking information,

where the system further comprises a disabling system for disabling the vehicle operation based on the toll payment information.

This system uses a satellite navigation receiver to enable infrastructure-free road tolling to be implemented. The system includes a function disabling the vehicle if the road toll fees have not been paid. This saves effort in tracking down users that do not pay their tolls.

The memory device can be part of a vehicle ignition control system, wherein the disabling system of the vehicle-mounted unit cooperates with the vehicle ignition control system to implement the disabling of the vehicle operation. Thus, a memory device functions both as an electronic ignition control device and as the toll payment record. The vehicle ignition control device can comprise an electronic key enabling the driver to start the vehicle. In other words, an electronic key used by the driver to start the vehicle also stores the road toll information. The memory device can comprise a smart card. The memory device is removable from the vehicle-mounted unit when it forms part of an electronic ignition key.

7The system preferably further comprises a mobile telephony receiver. This can be used to update a road toll pricing structure within the memory device. It can also be used to relay information about the roads used and/or road tolls to be charged to a central invoicing centre (for a post-pay system).

The mobile telephony receiver can also implement a position tracking function, and the system can then further comprise means for verifying correspondence between the position tracking information of the mobile telephony receiver and of the satellite navigation receiver.

This provides a way of preventing a so-called fake GPS attack, i.e. providing false GPS data to reduce the road tolls payable.

The memory device can store toll values for post-billing or prepaid toll values.

The memory device also stores road pricing data, and this may be for a local region, for example of less than 100 km radius. Additional road pricing data can then be obtained using mobile telephony system as and when needed.

The disabling system will provide a safe cut-off, for example it may be implemented only when the vehicle ignition is off and/or only when the vehicle is at a specified home location.

Examples of the invention will now be described with reference to the accompanying drawings, in which:

FIG. 1 shows how vehicle telematic systems are expected to grow in Europe in the future;

FIG. 2 shows how road toll systems in particular are likely to evolve;

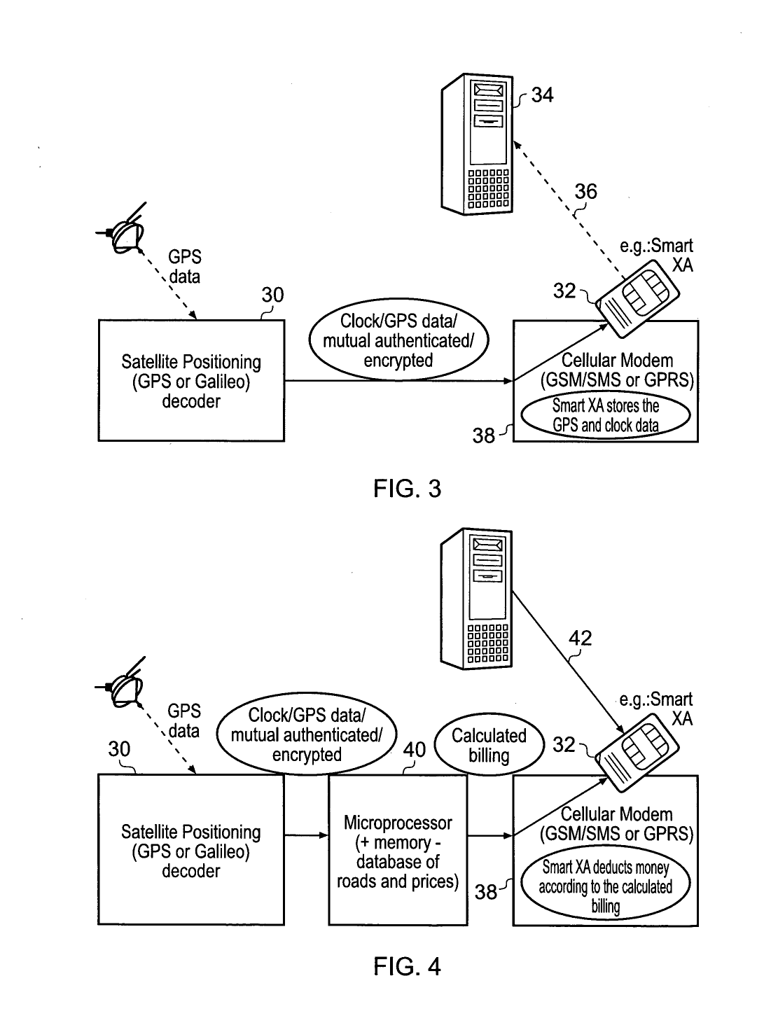

FIG. 3 shows a first example of system of the invention; and

FIG. 4 shows a second example of system of the invention.

The invention provides a road toll system in the form of a vehicle-mounted unit having a satellite navigation receiver implementing a position tracking function. The system determines the routes taken by the vehicle based on the position tracking information, and has a disabling system for disabling the vehicle operation based on the toll payment information.

FIG. 3 shows a first implementation of the invention, based on an off-line minimal client system for infrastructure-less road tolling.

GPS data is captured by the GPS receiver 30. This data is decoded to position data (longitude-latitude). The position data together with timing (clock) data is stored in memory 32 in the form of a Smart card (Smart XA). Periodically a batch of stored data is sent to the back-end road tolling server 34, as shown by the batch download 36. This can be ideally done by a GSM function (General Packet Radio Service “GPRS” or Third Generation mobile telephony “3G”) using a cellular modem 38. The back-end server is able to reconstruct out of this data the journeys that are driven.

The server also contains a database of road prices which were valid at a certain time. Finally the total price is computed and the driver gets an invoice (e.g. monthly).

In order to assure that data is not tampered by the user, data is exchanged in cryptographic way (e.g. DES are 3DES) between the GPS decoder and the tamper resistant environment of the memory 32. A Smart card provides a good tamper proof environment.

The needed memory size of the Smart card can be calculated based on average data shown below:

| | |
|---|---|
| km/year | 100000.0 |
| No. days/year | 200.0 |
| No. hours/day | 8.0 |
| average km/h | 62.5 |
| 1% accuracy (m) | 625.0 |
| Max distance between GPS fix(m) | 312.5 |
| No. sec between two fixes | 18.0 |
| No. fixes/month | 26666.7 |
| Bytes/GPS fix | 4.0 |
| Min needed memory/month (Kbyte) | 106.7 |

If the total income from road tolling is to be approximately the same as the actual tax income from existing taxation, the average cost/km is very small. Each journey is thus very small, which means a continuous on-line transaction scheme may not be desirable, hence the desire for a batch download.

This type of transaction scheme is much in line with current known electronic purse schemes used by the banking world.

There are variations to this basic configuration.

Firstly, it is possible not to store raw GPS data, but to store the decoded position information. This reduces the storage requirements and the batch transfer volume.

The system can be modified to enable the user to obtain the actual price information of the road he is driving. This could be obtained by using a real time on-line enquiry system and data transmission. For example, pushing a price request button will send the latest GPS coordinate to the server, and the server responds with road price, which is then displayed to the user. This provides a low cost service.

With simple GPS laboratory equipment, a fake transmitter can be built that can be mounted in the neighbourhood of the receiver. This transmitter will send out fake data. This attack should be avoided. A possible counter measure is to arrange for the received GPS location data to be compared with triangulation data obtained from GSM data obtained by the cellular modem. Both results should be within an accuracy limit.

One aspect of the invention is to provide vehicle Immobilization after non-payment of the road toll. This type of system is radical, but might be needed in some persistent situations. This immobilization requires a separate installation in the car. This immobilization circuitry is then related to the key management and ignition of the car. In a preferred implementation, the Smart card has the dual function of the ignition control device (which is known to those skilled in the art) and the road toll payment memory device.

In this implementation, the smart card is a removable electronic key. The driver of the vehicle uses the electronic key to start the vehicle, and indeed the electronic key may also function to open the vehicle doors. The vehicle then has an electronic system for reading/writing information from/to the smart card, and this electronic system forms part of the both the ignition control system and the road toll satellite navigation system. This makes fraudulent use of the system more difficult, as a single smart card is required by the driver which is valid for gaining entry to and driving the vehicle, and has an appropriate road toll payment record.

The road toll system then cooperates with the existing ignition control system to implement the disabling function, so that the overall system, including the disabling function, can be implemented with limited additional circuitry.

In order to maintain authenticity and non-tampering of such an infrastructure, a mutual authentication mechanism should be installed between the immobilization circuitry and the road tolling client.

The immobilization system must be safe. If implemented with the car in motion, it should not result in the car immediately stopping. A safe status for implementing the immobilization can be derived from the GPS data in combination with the ignition status ‘off’. For example, the driver can define a home location, and if the GPS data detects this position and if the car is in the ignition-off state for a time period (e.g. 1 hour), the immobilization status can be activated.

By having the ignition status available, the beginning and the end of a journey can be identified, allowing a quicker calculation of the batched data at the server.

The link to the ignition can be made via a CAN (Controller Area Network) bus. In many cases, a CAN bus is not available in the vehicle, and an RF key link may instead be used to make the connection between the ignition and the on board unit.

The first (“cold start”) GPS fix can take a long time particularly if the cold start GPS data is difficult to retrieve. If conditions are detected which hinder the GPS fix (such as mountainous or city locations) then only the GPS satellite stream can be recorded, the decoding of the location can be carried out subsequently in software, and also with the aid of the GSM data. In areas where GSM is also not available, the road tolling price may be zero or minimal and an indicator can be stored in the batched data for these conditions.

The latest GPS data stored can also be used as the start of a new journey.

There are some drawbacks with this system. Firstly, privacy protection is difficult. The system stores and transmits combinations of GSM, GPS and personal identity data to a central server system. Maintaining privacy protection means the security needs to be at a total end-to end system level, including the server infrastructure.

The system is also based on post payment. Non-payment in such a system will only be noticed after a while. Indeed, the server only calculates batched data after a certain period (e.g. monthly). Invoices have to be sent and a payment period has to be given. In the case of non payment, 1 or 2 warnings have to be allowed. It can be seen that half a year for example will pass before immobilization can be imposed.

An advantage of the post pay system is that the client system requires very little processing, which will lead to a very low cost solution. The accuracy of the billing can be guaranteed by the server software and can be averaged and compensated over a long time period taking into account the previous intermediate results.

It is of course also possible to implement a prepayment system.

A prepayment system is shown in FIG. 4.

The GPS data is again captured by the GPS receiver 30. This data is decoded to position data (longitude-latitude). The position data together with timing (clock) data is sent to a microprocessor 40.

The microprocessor environment contains the database of roads and related prices. Thus, it can calculate the related cost of actual driving. This cost data is deducted from the prepay amount stored in the Smart card 32.

The data update of prices and roads is uploaded from the back-end server 34 transmitted over GSM (GPRS-3G) as shown by upload 42.

In order to assure that data is not tampered by the user, data again is exchanged in cryptographic way (e.g. DES are 3DES) between the various elements. Databases and pre-pay information are kept in the Smart card environment.

The smart card environment can also take up the role of deducting the amounts, or even performing the full microprocessor function. This is the ideal tamper resistant implementation.

This implementation requires the road and pricing data to be stored locally, but a complete database of roads and prices is not needed. In most cases, the car drives in a certain area (less than 50 or 100 km radius). This means that only a limited amount of road data has to be stored and updated. Eventually only frequently used roads can be stored.

Additional road information can be requested from the server and uploaded if the system detects GPS conditions outside the stored road information.

Pricing information will remain static for a long time for most roads. Updates may only be more frequent for highways/motorways. These updates may only happen at fixed times so they can be predicted. If prices change, updates can be delivered via the GSM system.

In order to avoid attacks on the client, tamper resistance is again crucial. The Smart card environment is already a good countermeasure. A level 3 to 4 FIPS or Common Criteria security level may be required, which most Smart cards meet. This reflects the fact that the transactions are of small amounts (“micro transactions”).

Other attacks are related to probing or changing the data on the interfaces between the various components (GPS-Microcontroller-Smart Card)

This may be countered by incorporating the whole computing needs into the Smart card and interfacing the Smart card through the existing SIM interface of the GSM unit. This provides a road toll SIM card. Communication between the GPS system and the SIM card can be based upon simple DES are 3DES encryption.

Further fraud countermeasures can be on product level or on subassembly level. The availability of an ultra fast interrupt that, upon activation, clears a part of memory or registers (e.g. key reference registers) is one approach to enable equipment makers to assure advanced countermeasures for tampering. A battery back up is needed to be able to initiate such interrupt action.

The interface to the immobilization unit (ignition related circuitry of the car) should be mutually authenticated in order to improve anti-tampering.

The Smart card prepayment system can operate much in line with known payment schemes for pre-pay phone cards. In this case, the driver needs to buy ‘miles in advance’. The client unit in the vehicle then deducts money for every mile driven. This implies that the client needs to know the actual price of the road.

This requires additional processing power as the vehicle unit must calculate the cost in addition to implementing the position tracking.

An advantage of this system is that there is no privacy issue, since all data remains in the client terminal. Another advantage is that safe immobilization can be initiated at the moment the money or miles limit has reached.

The Smart card used in the system can be only for deducting miles and not for other services. However, the use of a more general electronic wallet would allow the user to use the value for additional services.

The enforcement can be stationary, or mobile. In either case, photographic capture of the car license plate is made. A DSRC (Dedicated Short Range Communications) system is a potential technology, and DSRC applications are being developed for interrogating an OBU (On Board Unit). For example, if a car passes an enforcement control point, a picture is taken of the license plate and the time is registered. This information is sent to the enforcement office, where the license plate is linked to the Smart card ID.

Combining the enforcement office GPS data and the Smart card ID can reveal if the on board unit was valid or not at the moment of control. More advanced interrogation would require more real time processing with additional queries sent to the OBU via GPRS (General Packet Radio Service).

Precautions should be made that the enforcement system can be proven to be calibrated at the time of interrogation.

Payment methodologies are often described by using bank terminals or off line equipment. In the case of road tolling and viewing the system as described, all infrastructure is available to perform a direct on line payment with a clearing service.

The payment application is a separate software application residing in the Smart Card (for example a Java multi-application card). The communication to the clearing house is then done via the GSM infrastructure. The value on the card can be a road toll value rather than a real monetary value. In this case the loading of payment into the card is made by prior registration. The use of electronic cash (e.g. the Netherlands electronic cash system known as “Chip-Knip Proton”) is also possible. A real monetary value is stored on the Smart Card.

Storing electronic cash on the system would allow the payment for potential third party services (e.g. location based services) on the fly.

There are a number of likely requirements of any road toll system, and which can be met by the system of the invention.

The system will need to be governmentally imposed, and this will lead to the need for a certification of the unit that will be sold on the market by an authorising body.

Both legacy and OEM solutions are required to enable competition and retro-fitting. This means that system solutions should be easy to install (preferably no installation need). If installation is needed, tailor made solutions may be required for every brand of car. Installation can then be done in after sales service for cars that are already in the market. For new cars, production line or OEM fit solutions are possible.

The billing accuracy will typically need to be within 1%. The road tolling is likely to be on a long periodic basis (half a year, or 1 year) which allows averaging of deviations.

The privacy and security issues are of paramount concern, and these issues are discussed above. A prepay system will more easily meet privacy and security concerns.

The pricing structure needs to be dynamic and upgradeable.

The pricing information must be known to the user, but it is assumed above that some action can be required of the user to have the pricing structure presented.

A system is likely to be structured so that average income for the state per year and per driver is comparable with the income generated by existing taxes.

The two systems outlined above can meet these requirements.

Various additional features and modifications will be apparent to those skilled in the art.

1. A road toll system including a vehicle-mounted unit, comprising:
a satellite navigation receiver implementing a position tracking function;
a memory device storing toll payment information;
means for determining the routes taken by the vehicle based on the position tracking information,
where the system further comprises a disabling system for disabling the vehicle operation based on the toll payment information.

2. The system as claimed in claim 1, wherein the memory device is removable from the vehicle-mounted unit.

3. The system as claimed in claim 1, wherein the memory device is part of a vehicle ignition control system, wherein the disabling system cooperates with the vehicle ignition control system to implement the disabling of the vehicle operation.

4. The system as claimed in claim 3, wherein the vehicle ignition control system comprises an electronic key enabling the driver to start the vehicle, the electronic key including the memory device.

5. The system as claimed in claim 4, wherein the memory device comprises a smart card.

6. The system as claimed in claim 1, further comprising a mobile telephony receiver.

7. The system as claimed in claim 6, wherein the mobile telephony receiver implements a position tracking function, and wherein the system further comprises means for verifying correspondence between the position tracking information of the mobile telephony receiver and of the satellite navigation receiver.

8. The system as claimed in claim 1, wherein the memory device stores toll values for post-billing.

9. The system as claimed in claim 1, wherein the memory device stores prepaid toll values.

10. The system as claimed in claim 1, wherein the memory device stores road pricing data.

11. The system as claimed in claim 10, wherein the memory device stores road pricing data for a region of less than 100 km radius.

12. The system as claimed in claim 1, wherein the disabling system is implemented only when the vehicle ignition is off or only when the vehicle is at a specified home location.

13. The system as claimed in claim 1, wherein the memory device is adapted to store satellite navigation data before processing to derive position data.
